(19) United States
(12) Patent Application Publication
(10) Pub. No.: US 2002/0194133 A1
(43) Pub. Date: Dec. 19, 2002

(54) System and method for distributing digital content in a secure manner

(76) Inventors: Didier Castueil, San Francisco, CA (US); Catherine Blagden, Davis, CA (US); D. Alan Brown, Bristow, VA (US); Gerald D. Moseley, San Jose, CA (US)

Correspondence Address: GARY CARY WARE & FREIDENRICH LLP, 1755 EMBARCADERO ROAD, PALO ALTO, CA, 94303-3340, US

(21) Appl. No.: 10/126,271

(22) Filed: Apr. 19, 2002

Related U.S. Application Data
(60) Provisional application No. 60/285,437, filed on Apr. 19, 2001.

(51) Int. Cl. G06F 17/60

(52) U.S. Cl. 705/53

(57) ABSTRACT

A system for distributing digital content including a computer Content Distribution Device (CDD) peripheral that provides a hardware/software solution to deliver digital rights protection in a consumer environment. The content may be received via a personal computer and may be viewed on any television in the home. The system of security mechanisms allows for the distribution of any encrypted content (e.g., video, music, games, and the like) to a local cache. The content producer can then control the viewing/listening of its content through a secured feedback process. There are no points in the process where digitized data is available in the clear. Keys are released to individual consumers providing a reliable accounting process.

### CROSS-REFERENCE TO RELATED APPLICATIONS

This application claims priority to U.S. Provisional Application No. 60/285,437, filed on Apr. 19, 2001.

### FIELD OF THE INVENTION

The present invention generally relates to a system and method for distributing digital content and more particularly, a system and method for distributing digital content in a secure manner over a public network.

### BACKGROUND OF THE INVENTION

The Internet has, among other things, provided a new distribution channel for media rich content such as film and music. Along with the opportunity to capitalize on this new delivery process, comes the need to create quality digital content that is protected from unauthorized viewing/listening and duplication. Not only must the content be protected (e.g. encrypted), but the distribution system must also prohibit unauthorized users from being able to access complete files of digital content during the delivery process. The creation of Napster catapulted the music industry into the digital rights/protection quagmire and has forced the movie studios to work quickly to determine and develop ways to protect their intellectual property from Napster-like services and events. Therefore, ways to transmit protected, quality digital content using the Internet must be developed in order for the music and film industries to comfortably and confidently exploit and profit from this new distribution channel.

The desire to watch movies at home has led to the creation of several solutions that are problematic when considering the desire to protect and deliver DVD quality intellectual property. A DVD provides one key that in theory prevents the movie from being copied to a computer. If a movie can be copied to a computer, one has the capability to make unauthorized, digital copies. When the DVD key was stolen and posted to the Internet, unauthorized copying of DVDs became possible.

Several solutions exist to deliver streaming media to computers or set-top-boxes. These systems have the disadvantages of requiring expensive video servers and large broadband connections into the home, because a connection of at least 3 Megabits/sec is needed in order to deliver DVD quality video. Even where such broadband connections are available, a software program pretending to be a multimedia player can steal the digitized content. A software-only solution can help to protect the content, but cannot prevent the content from being stolen by a sophisticated hacker.

### SUMMARY OF THE INVENTION

This invention simulates all the essential properties of DVDs in that it allows for the delivery of DVD quality content with chapter selection and VCR control functionality such as pause, fast forward, and rewind. In addition, it provides content producers with a mechanism for protecting digital rights never before realized in the video on demand environment. Specifically, this invention provides an external extension to a personal computer called a content delivery device (CDD) that decrypts the encrypted digital content and delivers it directly to a display or playing device such as a television, a monitor or a stereo system.

The primary value of this CDD to content producers is that the digital content may be delivered to, and reside on a personal computer. However, the content remains encrypted and cannot be viewed or played without authorization from the content producers. The encrypted content can be copied and distributed, but those copies also cannot be seen or listened to until the content producers give authorization.

The CDD allows a consumer to request access to digital content. At that time, the CDD requests a decryption key from the content producer. The content producer encrypts the digital content's secret keys into a message that is encrypted using a public key associated with that specific CDD.

The digital content's secret keys are never seen by the consumer's personal computer; the encrypted message is passed to the CDD where it is decrypted using a private key that resides on the CDD. This private key is also never seen by the consumer or the manufacturer, and is used to decrypt the encrypted digital content that has been sent to the consumer's PC. The digital content is then converted to an analog signal that is displayed/played on a television, computer monitor, or stereo system.

The content producer may have full control of the content and its playback capabilities, including the presence/absence of rewind and pause functionality, the number of times the content can be viewed or listened to, timed access rights, and determined fees to access the content.

The content producers can have a direct relationship with end users/consumers without the need to rely on third-party aggregators. Also, the system is flexible and will support any encoding and encryption techniques the content producer chooses to employ.

According to a first aspect of the present invention, a method is disclosed for providing digital content to a consumer in a secure manner. The method includes the steps of: providing a content delivery device to the consumer; authenticating the content delivery device; passing an encrypted message including at least one decryption key to the authenticated content delivery device; decrypting the encrypted message within the content delivery device to obtain the at least one decryption key; communicating the digital content in encrypted form to the content delivery device; using the decryption key to decrypt the digital content within the content delivery device; and outputting the decrypted digital content in analog form to a playing device.

According to a second aspect of the present invention, a system for providing digital content to a consumer in a secure manner is disclosed. The system includes a content delivery device for receiving and decrypting the digital content. The content delivery device includes a timing circuit and a volatile memory unit that stores a first key for decrypting a message that includes a second key for decrypting the digital content. The timing circuit is adapted to allow access to the volatile memory unit for a predetermined period of time while the content delivery device uses the first key to decrypt the message to obtain the second key, and to cause the volatile memory unit to be erased if the predetermined period of time expires.

These and other features and advantages of the invention will become apparent by reference to the following specification and by reference to the following drawings.

### BRIEF DESCRIPTION OF THE DRAWINGS

FIG. 1 is a schematic diagram of a system for distributing digital content according a preferred embodiment of the present invention.

FIG. 2 is a block diagram of an embodiment of a content delivery device that may be implemented within the system shown in FIG. 1.

FIG. 3 is a block diagram illustrating a circuit that may be employed within an embodiment of the invention to prevent the content delivery device's keys from being stolen.

FIG. 4 is a diagram illustrating a method for encrypting and decrypting messages and for authenticating the sources of messages according to a preferred embodiment of the present invention.

### DETAILED DESCRIPTION OF A PREFERRED EMBODIMENT OF THE INVENTION

### 1. General System Architecture

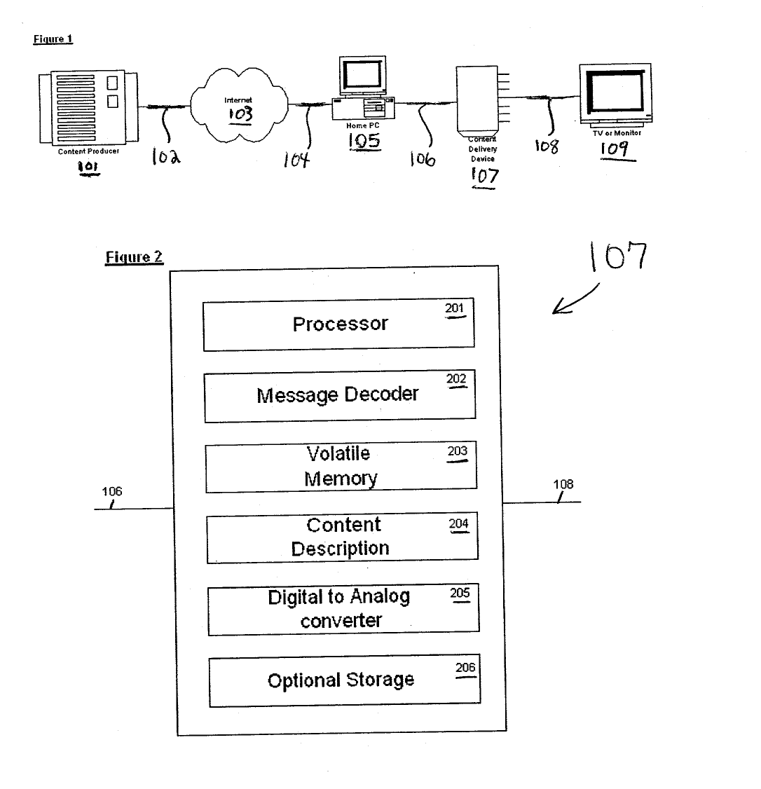

FIG. 1 shows a digital rights protection system 100 for distributing digital content according to a preferred embodiment of the present invention. System 100 includes a content delivery device (CDD) 107 as an extension to an existing home PC 105. The connection 106 may be any home network technology (e.g., HPNA, Ethernet, or the like) and may be adapted to allow the CDD 107 to be placed near a viewing or listening device 109. The connections 106, 108 are analog connections, thereby preventing any opportunity to copy a digital signal.

The content producer 101 encrypts the digital content in a known manner using its encryption technology of choice. This encryption results in one or more secret keys that will be sent to the consumer once the CDD 107 has been authenticated, following the authentication process that is described below and illustrated in FIG. 4. The encrypted content can be distributed via any private or public network 103 and by any connection to these networks (e.g., connections 102 and 104). The encrypted content is cached outside of the network at the consumer's site in a standard personal computer 105 and is kept there until the consumer requests to view/listen to the content. The CDD 107 is never used as a decoding box, non-critical messages such as play and configuration are sent non-encrypted. Only authentication and key transfers are sent encrypted using the public key (CPuK) associated with the device. Software updates may be sent using the same techniques used for content. The software updates may also be encrypted using secret keys and the secret keys may be sent using the methodology illustrated in FIG. 4.

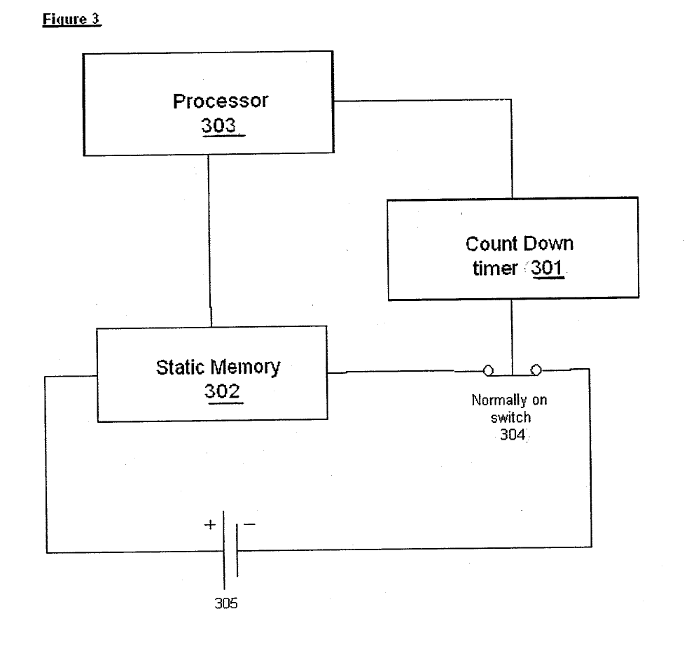

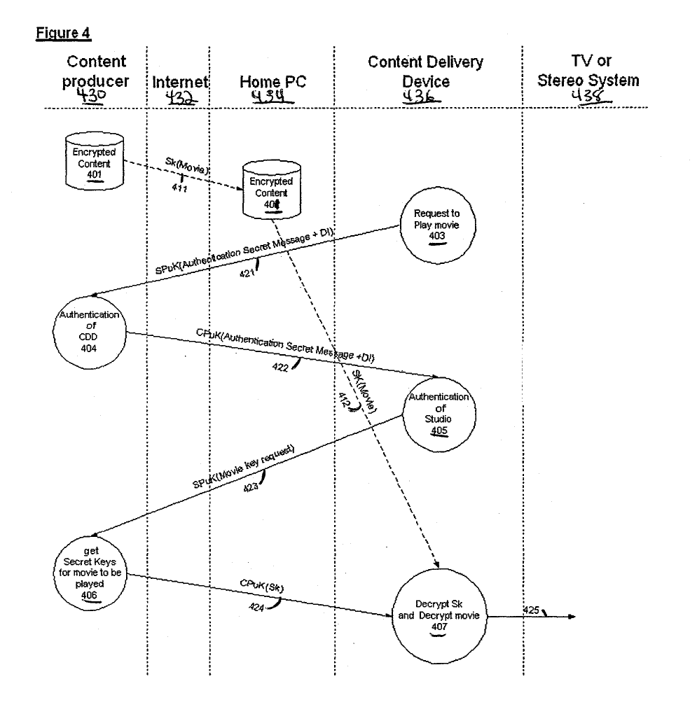

FIG. 2 shows the CDD 107, which may be configured to implement the digital rights protection system 100 according to a preferred embodiment of the present invention. It includes a conventional processor 201 that is adapted to run the processes of a) managing the private keys (CPrK) and decoding messages received via the connection 106 from the PC 105; b) managing the interface to the content producers 101 via connections 104, 102; c) retrieving the encrypted content via connection 106 from the PC 105; d) decrypting the content using the secret keys (Sk) received from the content producers 101; and e) managing the interface of the digital to analog converter 205 to deliver the desired content via connection 108 as an analog signal. The message decoder 202 is a timed process further described in FIG. 3 that retrieves the private key (CPrK) from the volatile memory 203 to decrypt the message sent by the content producer 101 using the CDD's (e.g., CDD 107) associated public key (CPuK). Content description 204 is a software process that determines the source of the content and the viewing/listening capabilities (e.g., pause, rewind, fast forward, stop, play, and the like) given to the consumer. In some implementations, an optional auxiliary storage unit 206 can be added to the CDD 107 to eliminate the permanent connection 106, and to give the consumer a choice of content via a storage/jukebox device that can store a variety of encrypted and encoded content.

FIG. 3 shows the technology required to prevent processes known as “single stepping” or Trojan Horse programs to be used to steal the CDD's private keys (CPrK). These keys are stored in the static, volatile memory 302 (e.g., SRAM) during manufacturing of the box. Memory 302 may represent and/or correspond to volatile memory 203 of FIG. 2. The volatile memory 302 is powered by a battery 305 via the specialized circuit. Access to the volatile memory can only occur while the countdown timer 301 is running, when the timer 301 is not running, the switch 302 is in a closed position. The switch is opened only for a predetermined period of time after the timer 301 expires. When an encrypted message is received from the content producer 101, the message can only be decrypted with the private key (CPrK) associated with that specific CDD, and the private key must be retrieved from the volatile memory 302 by processor 303, which may represent and/or correspond to processor 201 of FIG. 2. Before accessing the volatile memory 302, the processor initializes the countdown timer with a time approximately equal to the known processing time required to decode the message (proportional to the length of the encrypted message). Once the timer is started, the processor reads the private key (CPrK) by decrypting it, utilizing the specified implementation process, and uses the decrypted private key (CPrK) to decode the message. After the message is decoded, the processor turns the countdown timer 301 off before it expires, thus keeping switch 304 in a closed position. If a Trojan horse or “step through” technique is attempted during the decoding process the altered processing time will cause the countdown timer 301 to expire, thereby causing the power circuit to open the volatile memory 302. When the circuit is open, power to the volatile memory is lost causing the private keys (CPrK) to be erased rendering the CDD 107 nonfunctional, and thus protecting the content producer's intellectual property.

To further protect the private keys (CPrK), the CCD 107 is designed so that if someone attempts to open the box, the connection between the volatile memory 302 and the battery 305 is routed through the enclosures such that attempts at opening or breaking open the CDD 107 will break the wires causing power to the volatile memory 302 to be lost, thereby deleting the private keys (CPrK). The CDD's circuit board is constructed with the power plane on one of the two outside surfaces and the ground plane on the other. Thus all critical traces are located in the internal trace planes, making it extremely difficult to probe them without compromising the functionality of the board. All critical chips will be mounted on the board using a Ball Grid Array (BGA) configuration so that the leads are located under the chips to prevent probing. It should be appreciated that the particular configuration of the CCD 107 may vary based on aesthetics, packaging, cost and other concerns, and one of ordinary skill in the art will know how to arrange the memory 302 and battery 304 within the CCD 107 based on the particular configuration used in order to best achieve the foregoing protections.

In the preferred embodiment, the initialization of the CDD 107 is performed without the private key (CPrK) being seen by the manufacturer using the following process: a) the generation codes for the key pairs (CPrK and CPuK) are loaded in the device together with a set of random numbers; b) the key pairs are generated internally and the private keys (CPrK) are stored in the volatile memory; and c) the CDD's associated public keys (CpuK) are returned to the manufacturer who then distributes them with the appropriate serial number for that CDD, to the various content providers.

### 2. Digital Rights Protection Method

FIG. 4 shows a method for encrypting and decrypting the messages and for authenticating the sources of the messages according to a preferred embodiment of the invention. As discussed below, the method includes two independent processes that unite, and together enable the content to be decrypted in step 407, thereby allowing the content to be listened to and/or viewed.

The content delivery process starts when the content producer 430 encrypts the content 401 using a set of secret keys (Sk). The content, excluding the keys, is released for distribution to potential consumers who can download the encrypted content 401 into their respective PCs 434 over the internet 432, as shown by arrow 411. The content cannot be decrypted until the content producer 430 authenticates the consumer (e.g., by verifying the CDD 436) and gives permission to listen to/view the content by sending the appropriate secret keys (Sk) necessary to decode the content, thereby keeping the intellectual property protected from unauthorized listening/viewing.

When a consumer is in possession of encrypted content on their PC 434 and wants to listen to/view the content, the consumer must request to do so (step 403) by sending a message to the content producer 430, as shown by arrow 421. The message 421 is built using the private key (CPrK) associated with a specific CDD that generates a digital ID, and is encrypted using the content producer's public key (CPuK). This secret message digitally identifies itself to the content producer 430, by requesting to be verified. The content producer uses its associated public key (CPUK) to verify the secret message and the assigned serial number of the CDD 436, and thereby determine the identity of the CDD 436, as shown in step 404. The secret message is specific to a particular implementation and is used to prevent Trojan horse attacks. Separate public keys (CpuK) may be used to encrypt the secret message, and to verify the digital ID to further complicate any potential crypto-analysis process. Once the CDD 436 is authenticated, the content producer can generate the digital ID, and can encrypt the authentication message, shown by arrow 422, back to the CDD 436 using the public key (CPuK) associated with that CDD 436. The CDD 436 is then able to authenticate itself to the content producer 430, as shown in step 405. The CDD 436 may then request the secret keys that are be used to decrypt the selected content (e.g., the keys corresponding to the selected movie or music selected), as shown by arrow 423. The content producer 430 then retrieves the secret keys for the movie/music to be played in step 406, and sends the encrypted secret keys (Sk) using the CDD's public key (CPuK) in a message to the CDD 436, as shown by arrow 424.

The CDD 436 uses its private key (CPrK) to decrypt the content's secret keys (Sk) following the process of FIG. 3, as shown in step 407. Now the CDD 436 is able to retrieve the encrypted content, as shown by arrow 412, and to use the unencrypted secret keys (Sk) to decrypt that content, as shown in step 407. Once the content has been decrypted, the CDD 436 may send the unencrypted content in analog form to be displayed/played (e.g., by a television and/or stereo system 438), as shown by arrow 425.

Thus, the invention offers numerous advantages over conventional solutions. To effectuate the protecting of digital rights, digital content may be provided to a consumer via a public network and PC, yet the consumer's access to that content may be controlled. The digital content may be encrypted with secret key(s) and a variety of steps may be employed to protect and deliver the key(s) to a consumer in order to enable access to the content. Using a device, such as a CDD, content may be delivered to the user. One or more private keys may be stored in the CDD that is constructed to hide the key(s) in its volatile memory by periodically changing the storage algorithm. The location of a key in memory is a function of the date and a set of bits from the CDD serial number. The function is downloaded with the periodic software updates. Further, the CDD may include a circuit of volatile memory and a power source so that if the CDD is open, the power is interrupted and the unit becomes non-functional.

A watchdog timer may also be provided and kept alive while the private key is retrieved and used to decrypt messages. If the watchdog timer expires, the volatile memory containing the private key will lose power. Advantageously, the board design provides no probable data points for unencrypted content. Software and software updates for the CDD may be delivered via the same secured channel used for content, thereby preventing the inclusion of Trojan Horse software by hackers.

A content producer can deliver the public keys (CpuK) that match the private keys (CPrK) associated with a specific CDD in order to authenticate a user, and then release the content to that CDD according to particular processes, which are discussed herein.

Of course, alternative embodiments of the invention are also possible, and the above is merely illustrative of a particular embodiment.

What is claimed is:

1. A method for providing digital content to a consumer in a secure manner, comprising the steps of:
providing a content delivery device to the consumer;
authenticating the content delivery device;
passing an encrypted message including at least one decryption key to the authenticated content delivery device;
decrypting the encrypted message within the content delivery device to obtain the at least one decryption key;
communicating the digital content in encrypted form to the content delivery device;
using the at least one decryption key to decrypt the digital content within the content delivery device; and
outputting the decrypted digital content to a playing device.

2. The method of claim 1 wherein the decrypted digital content is output in analog form to the playing device.

3. The method of claim 2 further comprising the steps of:
communicatively connecting the content delivery device to a personal computer of the consumer; and
delivering the digital content in encrypted form to the personal computer of the consumer;
wherein the digital content is communicated in encrypted form from the personal computer to the content delivery device.

4. The method of claim 3 wherein the digital content is communicated in encrypted form to the personal computer over a public computer network.

5. The method of claim 1 wherein at least one private key is stored in the content delivery device for decrypting the encrypted message, and wherein the content delivery device is adapted to hide the private key in its volatile memory by periodically changing a storage algorithm.

6. The method of claim 1 wherein the content delivery device comprises a volatile memory device that stores a private key for decrypting the encrypted message, the method further comprising the step of:
interrupting power to the volatile memory device if the content delivery device is opened, thereby erasing the private key from the volatile memory device.

7. The method of claim 1 further comprising the steps of:
storing a private key for decrypting the encrypted message within the volatile memory of the content delivery device;
allowing access to the volatile memory for a period of time, effective to allow the content delivery device to use the private key to decrypt the encrypted message; and
erasing the volatile memory of the content delivery device if the period of time exceeds the time required for the content delivery device to decrypt the encrypted message.

8. The method of claim 1 further comprising the step of:
providing software updates for the content delivery device by use of a secured channel effective to prevent the inclusion of Trojan Horse programs.

9. A system for providing digital content to a consumer in a secure manner comprising:
a content delivery device for receiving and decrypting the digital content, the content delivery device including a timing circuit and a volatile memory unit that stores a first key for decrypting a message that includes a second key for decrypting the digital content, the timing circuit is adapted to allow access to the volatile memory unit for a predetermined period of time while the content delivery device uses the first key to decrypt the message to obtain the second key, and to cause the volatile memory unit to be erased if the predetermined period of time expires.

10. The system of claim 9 wherein the predetermined period of time is approximately equal to the time required for the content delivery device to decrypt the message.

11. The system of claim 9 wherein the timing circuit comprises:
a switch that is disposed between the volatile memory unit and a power source; and
a count down timer that is adapted to open the switch when the predetermined period of time expires, effective to disconnect the volatile memory unit from the power source.

12. The system of claim 9 further comprising:
a personal computer that is communicatively connected to a computer network and to the content delivery device, the personal computer being is adapted to receive the digital content in encrypted form over the computer network, and to selectively communicate the digital content to the content delivery device.

13. The system of claim 12 further comprising:
a playing device that is communicatively coupled to the content delivery device;
wherein the content delivery device is further adapted to output the decrypted digital content to a playing device.

14. The system of claim 13 wherein the content delivery device outputs the decrypted digital content in analog form to the playing device.

15. The system of claim 9 wherein the content delivery device further comprises a circuit including a power source that is coupled to a volatile memory unit, and that is adapted to interrupt power to the volatile memory unit if the content delivery device is opened, thereby erasing the private key from the volatile memory unit and causing the content delivery device to become non-functional.

16. The system of claim 9 wherein the content delivery device further comprises an auxiliary storage unit for storing digital content.
